(19) United States
(12) Patent Application Publication
(10) Pub. No.: US 2012/0300962 A1
(43) Pub. Date: Nov. 29, 2012

(54) Solar Powered Wireless Bluetooth Stereo Speaker With connectivity To MP3 Player

(76) Inventor: Alexander William Gregory Devoto, London (GB)

(21) Appl. No.: 13/115,974

(22) Filed: May 25, 2011

(51) Int. Cl. H04R 5/02; H04B 7/00

(52) U.S. Cl. 381/300; 455/41.3

(57) ABSTRACT

A portable Bluetooth stereo speaker including a rechargeable battery coupled to power the Bluetooth stereo speaker, a solar panel coupled to the rechargeable battery for recharging the battery when the solar panel is exposed to sunlight, a capacitive touch panel coupled to the Bluetooth stereo speaker for controlling music, skip track or volume, and a Bluetooth phone or MP3 player wirelessly coupled to send their music to the stereo speaker. A power boost function is coupled to the Bluetooth stereo speaker which turns on automatically to supply extra power to the speakers for louder, clearer sound playback when connected to an external charger.

### BACKGROUND OF THE INVENTION

1. Field of the Invention

The present invention relates to a solar powered wireless Bluetooth stereo speaker which combines integrated Bluetooth technology with solar powered battery support. The Bluetooth connectivity allows listeners to send their music wirelessly to the stereo speaker via their iPhone or MP3 player and enjoy the ease of remotely sending commands between the connected device and speaker, and vice versa. Superior sound quality is provided with the unit's 2×2 W speakers. Listeners can enjoy significantly higher volume and quality stereo sound, which has historically been lacking from direct mobile or MP3 playback. Maximum flexibility is obtained with an included retractable headphone Solar Sound cable which allows any MP3 player to be connected.

2. Description of Related Art

Bluetooth connected speakers are known in the prior art. More specifically, by way of example, U.S. PreGrant Publication No. 2009/0047905 to Yang discloses a stereo Bluetooth headset including a Bluetooth transceiver, an inter-speaker, a microphone and an audio output port. The inter-speaker is electrically connected to the Bluetooth transceiver for broadcasting audio signals received from the electronic device. The audio output port is electrically connected to the Bluetooth transceiver for connecting to an audio input port of an outer-speaker through a connecting cable to transmit stereo audio signals received from the electronic device to the outer-speaker through the connecting cable for broadcasting.

U.S. PreGrant Publication No. 2009/0197533 to Luk; et al. discloses a Bluetooth remote control wristwatch having a means for user-input to an included non-Bluetooth transmitter/receiver that wirelessly transmits the user-input to a modified Bluetooth remote control module having a non-Bluetooth transmitter/receiver that receives the user-input. The Bluetooth remote control module develops and wirelessly transmits a Bluetooth profile control signal to a Bluetooth-equipped device in accordance with the user-input at the wristwatch to establish wristwatch remote control of Bluetooth-equipped devices.

U.S. PreGrant Publication No. 2008/0070516 to Lee; et al. discloses a speaker system which includes an audio amplifier, a loudspeaker, a wireless communications module, and an electronic switch. The electronic switch receives an audio signal from an audio source and routes the audio signal to the audio amplifier or the wireless communications module.

U.S. PreGrant Publication No. 2008/0159565 to Kim discloses a headset for outputting audio data, adjusting a gain of a microphone in response to a change control signal of an output path of the audio data, and changing the output path of the audio data and an amplifying speaker for outputting the audio data provided through the headset.

U.S. PreGrant Publication No. 2008/0268777 to Lin discloses a magnetic adsorptive to combine a Bluetooth headset with a speaker base. The Bluetooth headset has an absorbable part and a signal-transmitting terminal. The speaker base has a headset receiving slot with a magnetic element and a control circuit board. When the Bluetooth headset approaches the headset receiving slot, the magnetic element absorbs the absorbable part of the Bluetooth headset to receive the Bluetooth headset in the headset receiving slot and electrically connects the signal-transmitting terminal of the Bluetooth headset with the control circuit board of the speaker base.

U.S. PreGrant Publication No. 2008/0287166 to LIN discloses a Bluetooth module, a wire-receiving unit having a wire slot, a wire-rolling disk, a communication wire, a volute spring, and a judging unit connected with the voice switching module and the wire-receiving unit. The volute spring allows the communication wire to be extended or received. One end of the communication wire is connected with the voice switching module. The other end of the communication wire is connected with the earphone. The judging unit outputs a judging signal to the voice switching module for switching the voice signal according to the communication wire being extended or received.

U.S. PreGrant Publication No. 2007/0042712 to Yuen discloses a speaker with large power, a corresponding speaking amplifying circuit and a switching circuit on an existing Bluetooth earphone. The user can adjust his/her Bluetooth earphone by switching to a different circuit so that it can work in earphone mode or speaker mode.

U.S. PreGrant Publication No. 2006/0046656 to Yang discloses when a calling signal from a mobile communication device is received by a Bluetooth transceiver, the audio signal transmitted to the stereo headset connected to the Bluetooth device is switched to the audio signal provided by the mobile communication device, and the audio signal transmitted to a speaker of the Bluetooth headset is switched to the audio signal provided by the mobile communication device.

### SUMMARY OF THE INVENTION

In an exemplary embodiment of the present invention, there is disclosed a portable Bluetooth stereo speaker comprising:

a rechargeable battery coupled to power the Bluetooth stereo speaker;

a solar panel coupled to the rechargeable battery for recharging the battery when the solar panel is exposed to sunlight;

a capacitive touch panel coupled to the Bluetooth stereo speaker for controlling the music, skip track or volume; and

a Bluetooth phone or MP3 player supporting the A2DP or AVRCP profiles wirelessly coupled to send their music to the stereo speaker;

wherein a power boost function is coupled to the Bluetooth stereo speaker which turns on automatically to supply extra power to the speakers for louder, clearer sound playback when connected to an external charger.

In another exemplary embodiment of the present invention, there is disclosed a method for providing a portable Bluetooth stereo speaker comprises:

providing a rechargeable battery coupled to power the Bluetooth stereo speaker;

providing a solar panel coupled to the rechargeable battery for recharging the battery when the solar panel is exposed to sunlight;

coupling a capacitive touch panel to the Bluetooth stereo speaker for controlling the music, skip track or volume; and

providing a Bluetooth phone or MP3 player supporting the A2DP or AVRCP profiles wirelessly coupled to send their music to the stereo speaker;

wherein a power boost function is coupled to the Bluetooth stereo speaker which turns on automatically to supply extra power to the speakers for louder, clearer sound playback when connected to an external charger.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of a portable stereo speaker which combines integrated wireless Bluetooth technology with solar powered battery support which allows listeners to send their music wirelessly to the stereo speakers via their phone or MP3 player in combination with the ability to remotely send “commands” between the connected device and the speaker and vice versa in accordance with the principles of the invention.

### DESCRIPTION OF THE PREFERRED EMBODIMENT

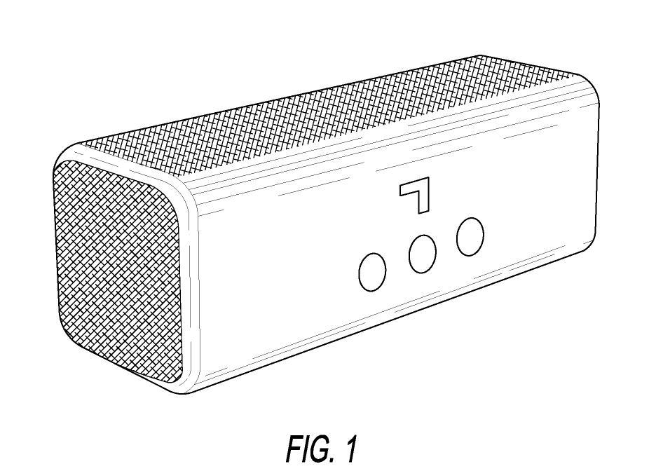

Referring to FIG. 1, there is shown a perspective view of the portable stereo speaker which combines integrated wireless Bluetooth technology with solar powered battery support which allows listeners to send their music wirelessly to the speakers via their iPhone or MP3 player in combination with the ability to remotely send “commands” between the connected device and the speaker and vice versa in accordance with the principles of the invention.

The compact, portable Solar powered wireless Bluetooth stereo speaker is the first portable stereo speaker to combine integrated Bluetooth technology with solar powered battery support. The Bluetooth connectivity allows listeners to send their music wirelessly to the speaker via their phone or MP3 player and enjoy the ease of remotely sending ‘commands’ between the connected device and speaker, and vice versa. Superior sound quality is provided by the unit's 2×2W speakers which allows listeners to now enjoy significantly higher volume and quality stereo sound, which has historically been lacking from direct mobile or MP3 playback.

The sound is compatible with the majority of phone models, including Nokias, Blackberry and the iPhone (with use of the iPhone 3.0 software update). Plus, an included retractable headphone cable allows any MP3 player to be connected ensuring maximum flexibility.

An integrated 150 mA solar panel which is displayed via an illuminated yellow logo when charging, supports a built in Lithium-Ion 1500 mAh battery which provides eight hours of continuous playing at medium volume or four hours at maximum volume.

The speaker has a compact size (16.5×5.5×5.5 cm), is light weight (260 g/0.5 lbs), includes a 3.5 mm retractable cable for added connectivity, and includes an AC-DC plug and charging cable. Furthermore, the unit includes the additional features of touch screen remote controls which provide forward, rewind and volume. In addition, a built in microphone is provided which allows it to be used for hands free communication when driving.

With the majority of listeners storing their music on either their iPhone or iPod, the invention disclosed provides higher quality sound from portable music devices and laptops, and steps away from the ‘tinny’ noise associated with direct laptops and phone speakers.

The Bluetooth speakers are light and portable while still being able to produce a deep, clear sound. With integrated Bluetooth, they can be connected wirelessly to most of the latest phones, including the iPhone (with use of the iPhone 3.0 or above software), have an integrated solar panel for charging in sunny areas, and a 3.5 mm connector and cable for use with music sources that do not have Bluetooth. The speakers are ideal for travel, are lightweight and can easily be carried in a backpack.

The solar powered wireless Bluetooth stereo speaker has the following specifications:
2×2 W speakers for proper stereo sound
Wireless connectivity to any Bluetooth® phone or MP3 player supporting the A2DP and AVRCP profiles
Plug into any standard headphone jack with an included 3.5 mm headphone retractable cable
Built in Microphone for hands free communication when paired with a suitable phone
Large solar panel for charging a built in Lithium-Ion 1600 mAh battery
Up to 10 hours continuous play time via Bluetooth from the battery and can even play without a battery on a sunny day.
Touch-screen panel for remotely controlling music, including Fast Forward and Rewind buttons, as well as Volume Control
Gold Plated audio connectors and silver coated, oxygen free copper speaker cabling
Line out function for streaming music over Bluetooth to a hi-fi
Includes an AC/DC plug and charging cable
Charging time is from 4 hours by AC/USB, or about 12-24 hours from solar panel

### Small Dimensions: 16.5×5.5×5.5 cm

Weight of about 320 g.
PowerBoost function

In addition, the solar powered wireless Bluetooth stereo speaker has the following features:

Acoustically optimized bass-reflex speaker cabinets

High quality audio components
Audio circuits optimized for signal quality
Use of higher quality Bluetooth BC5 audio chip
Capable of higher volume levels
Bluetooth sound quality much improved
Large 40 mm speakers
Inclusion of line-out audio connector.
Use of higher quality woven speakers
Large battery
Improved solar charging performance
Use of gold plated connectors
Use of silver coated oxygen free copper cabling for the speakers
Power Boost function
Front facing microphone.

The solar powered wireless Bluetooth stereo speaker can be connected to a Windows Vista PC or Laptop. Instructions for connecting Bluetooth on a Windows Vista PC or Laptop are as follows:

Note, the following instructions should work on most

Windows XP, Windows Vista and Windows 7 computers, although the process may vary slightly. The overall process of pairing, connecting audio and setting the audio output are applicable to most computer systems such as Linux and Apple OS-X.

1) Turn on the Bluetooth speaker and any physical Bluetooth switches on your laptop or PC or connect your Bluetooth dongle.

Next, open Windows control panel and select the
“Hardware and Sound” section.

2) Scroll down and click on “Bluetooth Devices”

3) Select “Add Wireless Device”, which will start the device searching and pairing process.

4) Select the Bluetooth speaker then click “next” to proceed pairing with the Bluetooth speaker. It may take up to 30 seconds to connect.

5) Your computer is now paired to the Bluetooth speaker, but you still have to connect the audio. To do this, click on “Bluetooth Settings”.

6) Click the “Audio” tab and check that “Bluetooth Stereo Audio” and “Bluetooth Hands-Free Audio” are both connected. If not, click them and press “connect”. When done, click “Ok” to exit.

7) Your computer is now fully connected to the Bluetooth speaker and you can exit the Bluetooth control window.

However, you must still select the Bluetooth speaker as an audio output in the windows settings. To do this, open the “Hardware and Sound” section of Windows control panel again, and click on “Manage Audio Devices”.

8) For stereo music or sound streaming, select the “Bluetooth Stereo Audio” option and click “Set Default”.

For Hands-free Audio using the microphone, select the “Bluetooth Hands-free Audio” and then “Set Default”.

### Click Ok.

Finally, before you can start using the Bluetooth speaker as an audio output you must restart (exit the software then open the software again) any software you intend to use, such as iTunes, Skype etc.

The Bluetooth speaker are compact and ultraportable while still being able to produce a deep, clear sound, With integrated Bluetooth, they can be connected wirelessly to most phones, including the iPhone 4, as well as other devices such as laptop computers, The speakers have an integrated solar panel for recharging and extending playback time in sunlight, and a 3.5 mm connector for use with music sources that do nor have Bluetooth. The speaker are ideal for travel, they are very robust and can easily be carried in a backpack. The long playback times from the integrated Lithium battery combined with solar recharging and high volume output means they are extremely convenient to use in a wide range of environments. To obtain more power, just plug the speaker into a supplied charger and a Power Boost function will turn on automatically to supply extra power to the speakers for louder, clearer sound playback

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A portable Bluetooth stereo speaker comprising:
a rechargeable battery coupled to power the Bluetooth stereo speaker;
a solar panel coupled to the rechargeable battery for recharging the battery when the solar panel is exposed to sunlight;
a capacitive touch panel coupled to the Bluetooth stereo speaker for controlling the music, skip track or volume; and
a Bluetooth phone or MP3 player supporting the A2DP or AVRCP profiles wirelessly coupled to send their music to the stereo speaker;
wherein a power boost function is coupled to the Bluetooth stereo speaker which turns on automatically to supply extra power to the speakers for louder, clearer sound playback when connected to an external charger.

2. The apparatus of claim 1 wherein the stereo speaker includes two-two watt speakers.

3. The apparatus of claim 2 wherein the Bluetooth stereo speaker is connected to a microphone for hands free communication.

4. The apparatus of claim 3 wherein the stereo speakers have woven cones.

5. The apparatus of claim 4 wherein the Bluetooth stereo speaker includes a headphone retractable cable for plugging into any standard headphone jack for use with a music source that does not have Bluetooth.

6. The apparatus of claim 5 wherein the headphone retractable cable is about 3.5 mm.

7. The apparatus of claim 5 wherein the rechargeable battery is a Lithium polymer 1600 mAh battery.

8. The apparatus of claim 7 wherein the rechargeable battery is supported by a 150 mA solar panel.

9. The apparatus of claim 1 wherein the portable Bluetooth stereo speaker can be connected to a Windows Vista PC or laptop.

10. A method for providing a portable Bluetooth stereo speaker comprises:
providing a rechargeable battery coupled to power the Bluetooth stereo speaker;
providing a solar panel coupled to the rechargeable battery for recharging the battery when the solar panel is exposed to sunlight;
coupling a capacitive touch panel to the Bluetooth stereo speaker for controlling the music, skip track or volume; and
providing a Bluetooth phone or MP3 player supporting the A2DP or AVRCP profiles wirelessly coupled to send their music to the stereo speaker;
wherein a power boost function is coupled to the Bluetooth stereo speaker which turns on automatically to supply extra power to the speakers for louder, clearer sound playback when connected to an external charger.

11. The method of claim 10 wherein the stereo speaker includes two-two watt speakers.

12. The method of claim 11 wherein the Bluetooth stereo speaker is connected to a microphone for hands free communication.

13. The method of claim 11 wherein the stereo speakers have woven cones.

14. The method of claim 13 wherein the Bluetooth stereo speaker includes a headphone retractable cable for plugging into any standard headphone jack for use with a music source that does not have Bluetooth.

15. The method of claim 14 wherein the headphone retractable cable is about 3.5 mm.

16. The method of claim 14 wherein the rechargeable battery is a Lithium polymer 1600 mAh battery.

17. The method of claim 16 wherein the rechargeable battery is supported by a 150 mA solar panel.

18. The method of claim 10 wherein the portable Bluetooth stereo speaker can be connected to a Windows Vista PC or laptop.
